(19) United States
(12) Patent Application Publication
(10) Pub. No.: US 2005/0160859 A1
(43) Pub. Date: Jul. 28, 2005

(54) Device to switch over a mechanical shifting means

(75) Inventors: Arnd Buerger, Einbeck (DE); Stephan Grossmann, Einbeck (DE); Gerald Bauerfeind, Trendelburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Teleflex Automotive Germany GmbH, Dassel (DE)

(21) Appl. No.: 11/019,822

(22) Filed: Dec. 22, 2004

(30) Foreign Application Priority Data
Dec. 24, 2003 (DE) DE 103 61 209.2

(51) Int. Cl. B60K 41/26

(52) U.S. Cl. 74/473.1

(57) ABSTRACT

A device to switch over a mechanical shifting means between at least two shifting states, particularly for purposes of switching on and off a parking lock of an external selector for an automatic transmission, whereby a shifting gate that can be actuated via a shift gear lever having a connecting rod such as a pull rod or push rod is arranged in a housing and the parking position is held by a locking magnet, whereby a locking lever having an axis of rotation is provided inside the housing, said lever interacting with the locking magnet, whereby the locking lever is connected via a bell crank having a blocking pin and having an axis of rotation to the pull rod or push rod having an axis of rotation, and to a link slide that can be moved relative to a shifting gate.

Priority is claimed to German Patent Application No. DE 103 61 209.2, filed on Dec. 24, 2003, the entire disclosure of which is incorporated by reference herein.

The invention relates to a device to switch over a mechanical shifting means between at least two shifting states, particularly for purposes of switching on and off a parking lock of an external selector for an automatic transmission.

### BACKGROUND

Automatic transmissions equipped with mechanical parking locks are known from the state of the start.

A conventional automatic transmission for motor vehicles usually comprises at least four operating modes, corresponding to the shifting positions “P”, “R”, “N” and “D” on the gearshift lever. As is known, “R” stands for reverse, “D” for drive and “N” for neutral, in which the engine and the wheels are mechanically disengaged.

“P” stands for “park”, a state in which the gear is mechanically locked by a parking lock against the transmission of movements. A common safety requirement in this context is that, when the car is at standstill, the mechanical parking lock of the automatic transmission is always set or can always be set.

In the case of an automatic transmission with a mechanical transmitting member such as, for instance, a gearshift linkage located between the gearshift lever and the automatic transmission, the mechanical transmitting member can force a coupling between the actual shifting state of the gear and the displayed shifting state of the gearshift lever. Even in case of a power failure in the vehicle, the gearshift lever can be moved into the “P” shifting position and the mechanical coupling can shift the automatic transmission into the corresponding state with the parking lock engaged. The parking position “P”, however, can only be disengaged when the brake pedal is depressed and when the on-board electrical system is being supplied with power. For this purpose, conventional systems make use of the principles of toggle levers or solenoids, which directly block a connecting rod, such as a pull rod or push rod. These mechanisms, however, limit the pre-stressing forces that can be overcome and they also give rise to noise.

### SUMMARY OF THE INVENTION

It is an objective of the invention to provide a device with which the drawbacks of the prior-art solutions can be prevented and which fulfills the above-mentioned safety requirements made of automatic transmissions. In particular, it is an object of the present invention to provide a device that allows an easy disengagement of the parking position of an automatic transmission, even if the system is pre-stressed, for example because a pushbutton was actuated prior to depressing the brake pedal.

The present invention provides a device to switch over a mechanical shifting means between at least two shifting states, particularly for purposes of switching on and off a parking lock of an external selector for an automatic transmission, whereby a shifting gate (6) that can be actuated via a shift gear lever (8) having a tie rod or push rod (5) is arranged in a housing (7) and the parking position is held by a locking magnet (1). The device includes a reversing lever (3) that can pivot around an axis of rotation (12) and whose one side limits the path of a link slide (14) relative to the shifting gate (6) and whose other side has a blocking pin (9) that is moved along a locking groove (10). In addition, the device includes an angled locking lever (2) including two legs (15, 16) that can rotate around an axis of rotation (11) in the housing (7), whereby a locking magnet (1) acts against one leg (16) and the locking groove (10) runs along the other leg (15) and guides the blocking pin (9). The locking lever (2) is positioned in the parking position (P) in such a way that the locking groove (10) does not release the radius of motion of the blocking pin (9) and the reversing lever (3) is locked without current, whereby the tie rod or push rod (5) cannot be moved out of the shifting gate (6).

The device according to the invention makes use of the principle of a triple lever transmission whereby consequently, the effective pre-stressing force exerted on the locking magnet can be reduced. Here, a bell crank is fitted with a blocking pin that is arranged in such a way to achieve a reduction of the pull rod or push rod relative to the blocking pin, whereby there is also a locking lever with a locking groove in which the blocking pin of the bell crank can move freely along a radius of motion.

Accordingly, a locking lever having an axis of rotation is provided inside a housing, the locking lever interacting with the locking magnet, whereby the locking lever is connected via a bell crank having a blocking pin and axis of rotation to the pull rod or push rod, and to a link slide that can be moved over a shifting gate.

Advantageously, the link slide extends in a U-shaped or bridge-like manner over the shifting gate, whereby the bell crank lies on a lateral bracket of the U-shaped or bridge-like link slide.

The parking position “P” is held by a spring of the locking magnet, whereby the locking lever is positioned in the parking position P in such a way that the locking groove does not release the radius of motion of the blocking pin and the bell crank is locked without current, and the pull rod or push rod cannot be moved out of the shifting gate. Therefore, the locking magnet then only has to work against the friction torque of the blocking pin of the bell crank in the locking lever. As a result, it is advantageously possible to employ a small magnet that only has to generate small forces (cost savings), thereby also reducing the noise generated. Advantageously, the parking lock can be disengaged via a pulse to the locking magnet, whereby the locking lever can be moved in such a way that the locking groove releases the blocking pin in the direction of motion and the bell crank can be freely moved. By actuating the pull rod or push rod, it is then possible to shift between the positions R, N and D in the shifting gate.

### BRIEF DESCRIPTION OF THE DRAWINGS

The drawings show the following:

FIG. 1—in a perspective view, a general view of the device in its installed state inside an automatic transmission;

FIG. 1a—a schematic side view of the device without the front housing wall;

FIG. 1b—section A-A through the device according to FIG. 1a;

FIG. 1c—section B-B through the device according to FIG. 1a;

FIG. 1d—detail Z from FIG. 1b;

FIG. 1e—detail Y from FIG. 1c;

FIG. 2—in a perspective partial view, the device with the disengaged parking position in the installed state in a sectional view;

FIGS. 3 and 3a—in a perspective partial view, the device with the parking position in the installed state in a sectional view.

### DETAILED DESCRIPTION

The device according to the invention makes use of a triple lever transmission, thus reducing the effective pre-stressing force exerted on the locking magnet.

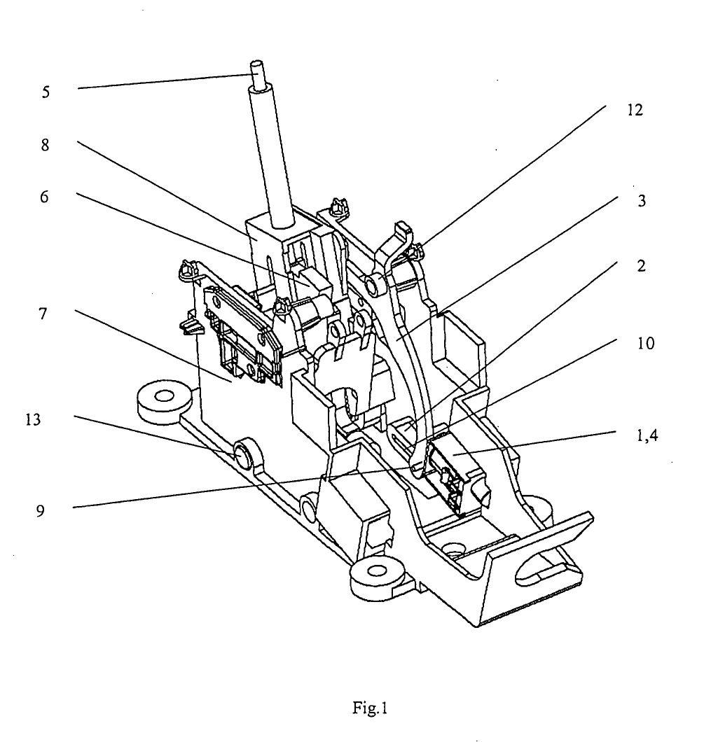

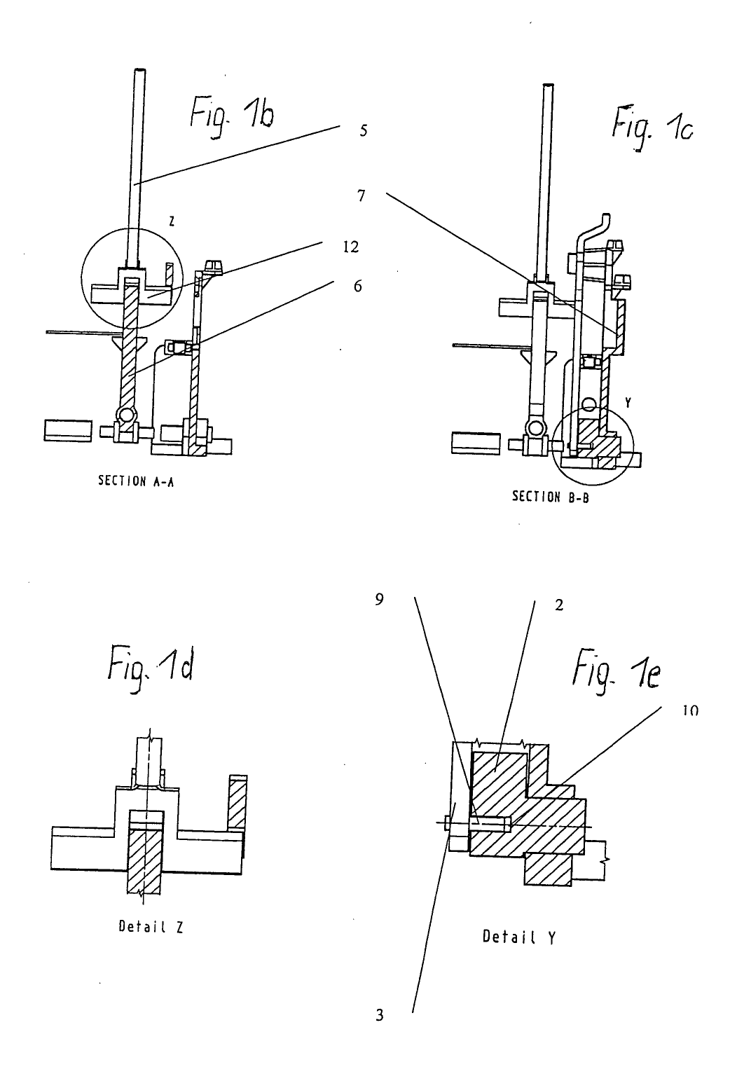

In FIG. 1, the device according to the invention is shown in the installed state in a housing 7 inside an automatic transmission. Here, manual shift gear lever 8 having a connecting rod 5, in this case a pull rod can be actuated in order to shift between the individual positions R, N, D and P in the shifting gate 6 of the automatic transmission. For this purpose, the pull rod 5 is fitted with a link slide 14 that extends in a U-shaped or bridge-like manner over the shifting gate 6, whereby a bell crank 3 lies on a lateral bracket of the U-shaped or bridge-like link slide 14 (FIGS. 1b and 1d).

Here, the bell crank 3, having axis of rotation 12, is arranged so as to achieve a reduction of the pull rod 5 relative to the blocking pin 9. The locking lever 2 has a locking groove 10 in which the blocking pin of the bell crank can move.

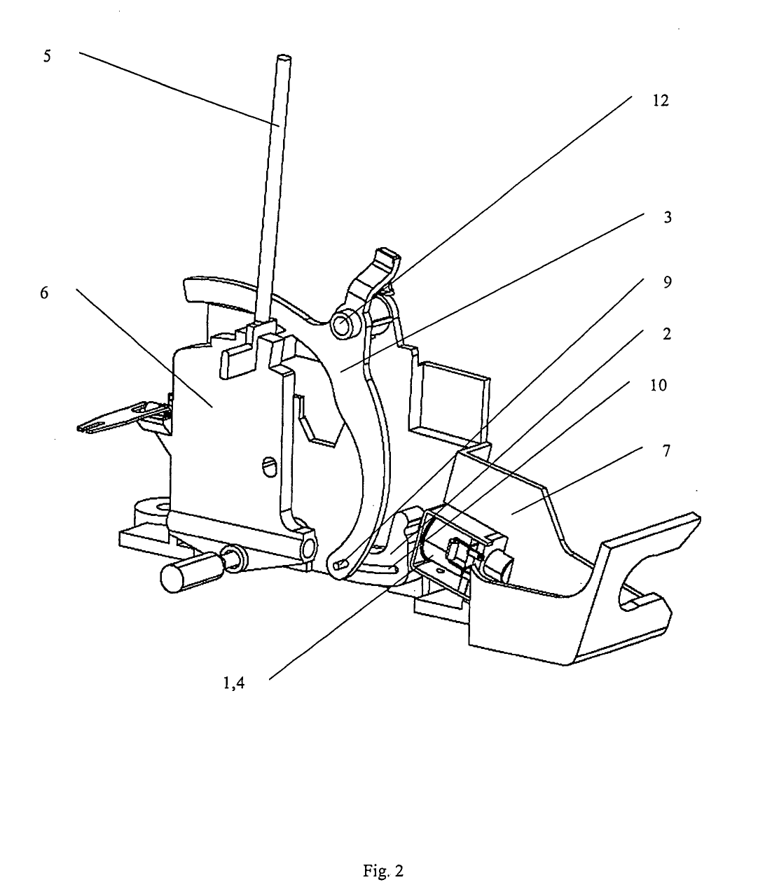

In the open state, that is to say, in the released parking position P (FIG. 2), the locking magnet 1 receives a pulse via the actuation of a pushbutton on the gearshift knob. As a result, the locking lever 2 is moved in such a manner that its locking groove 10 releases the blocking pin 9 in the direction of motion. Consequently, the bell crank 3 can move freely along the locking groove 10 until it no longer blocks the path of the link slide 14. By actuating the pull rod 5, it is then possible to shift between the positions R, N and D in the shifting gate 6.

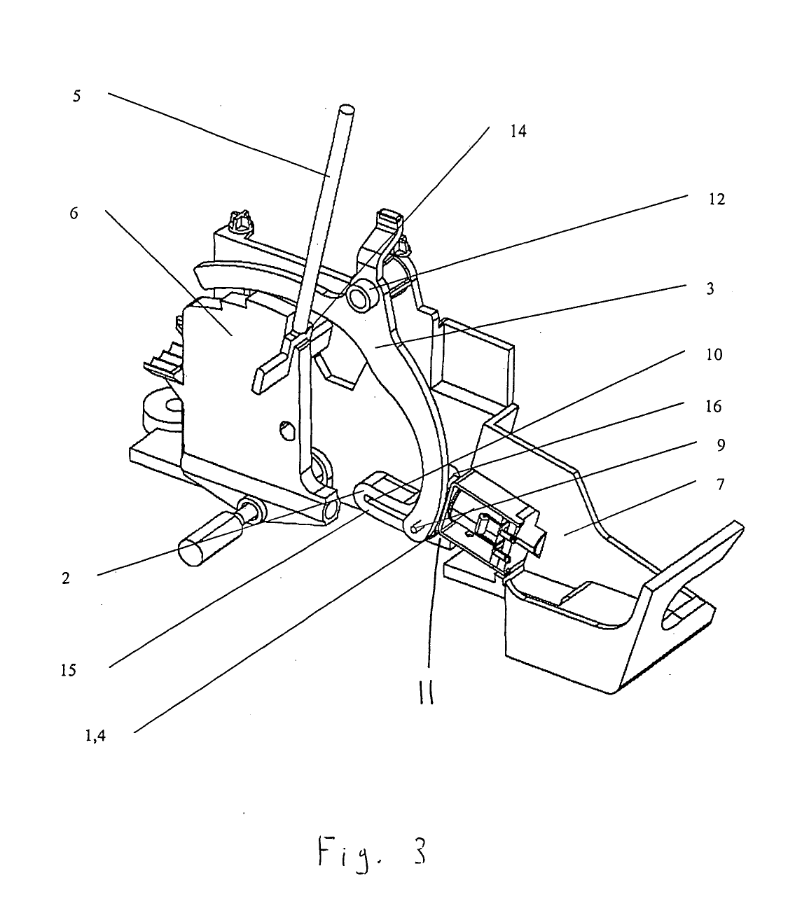

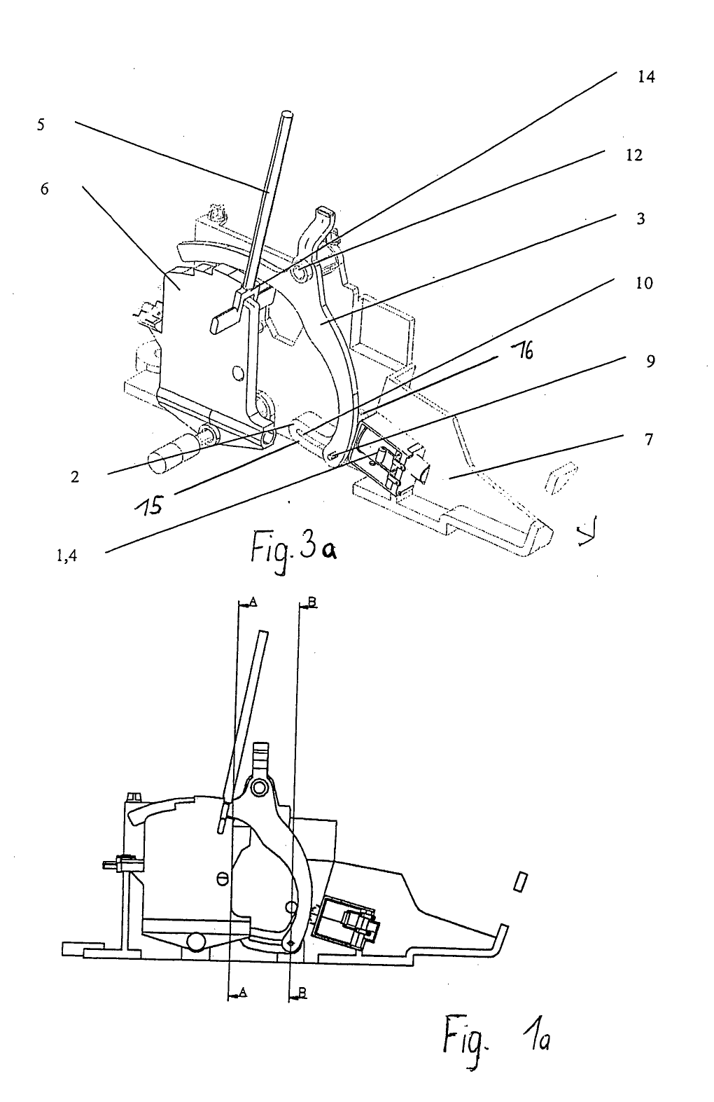

The parking position P (FIG. 3) is held by a spring 4 of the locking magnet 1. Here, the locking lever 2 is positioned in such a way that the locking groove 10 does not release the radius of motion of the blocking pin 9, that is to say, the blocking pin 9 pivots into the axis of rotation of the locking lever 11 which, at this point, coincides with the axis of the blocking pin 9 (FIGS. 1c and 1e). This further reduces the torque down to 0 Nm. The bell crank 3 is thus locked without current and the pull rod 5 cannot be moved out of the shifting gate 6. Therefore, the locking magnet 1 only has to still overcome the friction torque caused by surface pressure between the locking lever 2 and the blocking pin 9 of the bell crank 3.

The bell crank 3 can be designed in a flexible manner, thus allowing flexibility in terms of the space requirements and in terms of its use for systems having a pull rod and a push rod.

The device allows the disengagement of the parking position in an automatic transmission that is under pre-stressing because the pushbutton on the gearshift knob was actuated.

1. A device for switching over a mechanical shifting device between at least two shifting states, the device comprising:
a housing;
a gear shift lever and having a connecting rod;
a shifting gate disposed in the housing, defining a parking position and actuatable using the shift gear lever;
a link slide fitted on the connecting rod;
a bell crank pivotable about a first axis of rotation and having a first end portion configured to limit a path of the link slide relative to the shifting gate and a second end portion including a blocking pin;
an angled locking lever pivotable about a second axis of rotation in the housing and having a fist leg and a second leg, the first leg defining a locking groove configured to guide the blocking pin along a radius of motion of the blocking pin; and
a locking magnet configured act against the first leg,
wherein the locking lever is positioned in a first position in such a way that the locking groove prevents a radial movement of the blocking pin so as to lock the bell crank without current and so as to prevent the connecting rod from being removed from the shifting gate.

2. The device as recited in claim 1, wherein the at least two shifting states include an on state and an off state of a parking lock of an external selector for an automatic transmission.

3. The device as recited in claim 1, wherein the actuation rod includes one of a push rod and a pull rod.

4. The device as recited in claim 1, wherein the link slide extends over the shifting gate and includes a lateral bracket and the bell crank is configured to contact the a lateral bracket.

5. The device as recited in claim 4, wherein the link slide includes at least one of a U-shaped and a bridge-shape.

6. The device as recited in claim 1, wherein the locking magnet includes a spring and wherein the parking position is held by the spring.

7. The as recited in claim 1, wherein the locking lever is moveable to a second position in which the blocking pin is moveable within the locking groove in a direction of movement of the locking pin so that the bell crank is moveable.

8. A parking lock for locking and unlocking an automatic transmission shift gear lever in a parking gear, the parking lock comprising:
a shifting gate defining a parking gear position;
an actuation rod including a link slide portion engaging the shifting gate at the parking gear position;
a locking lever pivotable about a first axis of rotation and including a first leg defining a groove and a second leg;
a locking magnet configured to act upon the second leg so as to move the locking lever from a locked position to a second unlocked position; and
a bell crank pivotably mounted at an axis of rotation, the bell crank including a first end portion engageable with the link slide and a second end portion including a blocking pin engaging the groove, wherein in the locked position of the locking lever, the groove prevents movement of the blocking pin so that the second end portion engages the link slide to block the link slide portion at the parking gear position, and wherein, in the unlocked position of the locking gear, the blocking pin is moveable within the groove and the second end portion allows a disengagement of the link slide portion from the parking gear position.

9. The parking lock as recited in claim 8, wherein the locking magnet includes a mechanical spring, and wherein the spring moves the locking lever to the second unlocked position without the use of electric current.
